(19) United States
(12) Patent Application Publication
(10) Pub. No.: US 2025/0149031 A1
(43) Pub. Date: May 8, 2025

(54) AUTOMATIC UPDATING OF AUTOMATIC SPEECH RECOGNITION FOR NAMED ENTITIES

(71) Applicant: Samsung Electronics Co., Ltd., Suwon-si (KR)

(72) Inventors: Aditya Jajodia, Sunnyvale, CA (US); Akash Sahoo, San Jose, CA (US); Patrick Hegarty, San Francisco, CA (US); Divya Neelagiri, Dublin, CA (US); Vijendra Raj Apsingekar, San Jose, CA (US)

(21) Appl. No.: 18/816,659

(22) Filed: Aug. 27, 2024

Related U.S. Application Data
(60) Provisional application No. 63/596,574, filed on Nov. 6, 2023.

(51) Int. Cl. G10L 15/197; G10L 13/02; G10L 15/06

(52) U.S. Cl. CPC G10L 15/197; G10L 13/02; G10L 15/063; G10L 2015/0635

(57) ABSTRACT

A method includes identifying, using an automated speech recognition (ASR) system, at least one named entity hypothesis from at least one audio input. The method also can include providing, using the ASR system, the identified at least one named entity to a large language model (LLM). The method also can include generating a prompt using an automated prompt generator. The method also can include processing, using the LLM, the identified at least one named entity hypothesis and the prompt to generate updated named entity recognition data. The method also can include providing the updated named entity recognition data back to the ASR system.

### CROSS-REFERENCE TO RELATED APPLICATION AND PRIORITY CLAIM

This application claims priority under 35 U.S.C. § 119(e) to U.S. Provisional Patent Application No. 63/596,574 filed on Nov. 6, 2023, which is hereby incorporated by reference in its entirety.

### TECHNICAL FIELD

This disclosure relates generally to machine learning systems. More specifically, this disclosure relates to automatic updating of automatic speech recognition for named entities.

### BACKGROUND

Voice assistants have grown in popularity and the number of devices supporting voice assistant has increased. Robust voice recognition is important, otherwise errors can propagate to other tasks. Automated Speech Recognition (ASR) models can be trained in a variety of ways, such as via supervised, self-supervised, and semi-supervised training. For each type of training, it is important to have a correct balance of words (Audio or Text) present in the training data for the model to generalize and cover all scenarios. Many of the utterances directed towards voice assistant include named entities (NEs), and these NEs are becoming more complex.

### SUMMARY

This disclosure relates to automatic updating of automatic speech recognition for named entities.

In a first embodiment, a method includes identifying, using an automated speech recognition (ASR) system, at least one named entity hypothesis from at least one audio input. The method also can include providing, using the ASR system, the identified at least one named entity hypothesis to a large language model (LLM). The method also can include generating a prompt using an automated prompt generator. The method also can include processing, using the LLM, the identified at least one named entity hypothesis and the prompt to generate updated named entity recognition data. The method also can include providing the updated named entity recognition data back to the ASR system.

In a second embodiment, an electronic device includes at least one processing device. The at least one processing device is configured to identify, using an automated speech recognition (ASR) system, at least one named entity hypothesis from at least one audio input. The at least one processing device is also configured to provide, using the ASR system, the identified at least one named entity hypothesis to a large language model (LLM). The at least one processing device is also configured to generate a prompt using an automated prompt generator. The at least one processing device is also configured to process, using the LLM, the identified at least one named entity hypothesis and the prompt to generate updated named entity recognition data. The at least one processing device is also configured to provide the updated named entity recognition data back to the ASR system.

In a third embodiment, a non-transitory machine readable medium containing instructions that when executed cause at least one processor of an electronic device to identify, using an automated speech recognition (ASR) system, at least one named entity hypothesis from at least one audio input. The non-transitory machine readable medium also contains instructions that when executed cause at least one processor of an electronic device to provide, using the ASR system, the identified at least one named entity hypothesis to a large language model (LLM). The non-transitory machine readable medium also contains instructions that when executed cause at least one processor of an electronic device to generate a prompt using an automated prompt generator. The non-transitory machine readable medium also contains instructions that when executed cause at least one processor of an electronic device to process, using the LLM, the identified at least one named entity hypothesis and the prompt to generate updated named entity recognition data. The non-transitory machine readable medium also contains instructions that when executed cause at least one processor of an electronic device to provide the updated named entity recognition data back to the ASR system.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example voice assistant and named entity recognition system in accordance with this disclosure;

FIG. 3 illustrates an example process for automatically updating an on-device ASR system for named entity recognition in accordance with this disclosure;

FIG. 4 illustrates an example method for automating prompt generation in accordance with this disclosure;

FIG. 5 illustrates an example process for automatically updating an ASR system for named entity recognition using data pooling in accordance with this disclosure;

FIG. 6 illustrates an example process for automatically updating an ASR system for named entity recognition using data pooling and ungraded hypotheses in accordance with this disclosure; and

FIG. 7 illustrates an example method for automatic updating of automatic speech recognition for named entities in accordance with this disclosure.

### DETAILED DESCRIPTION

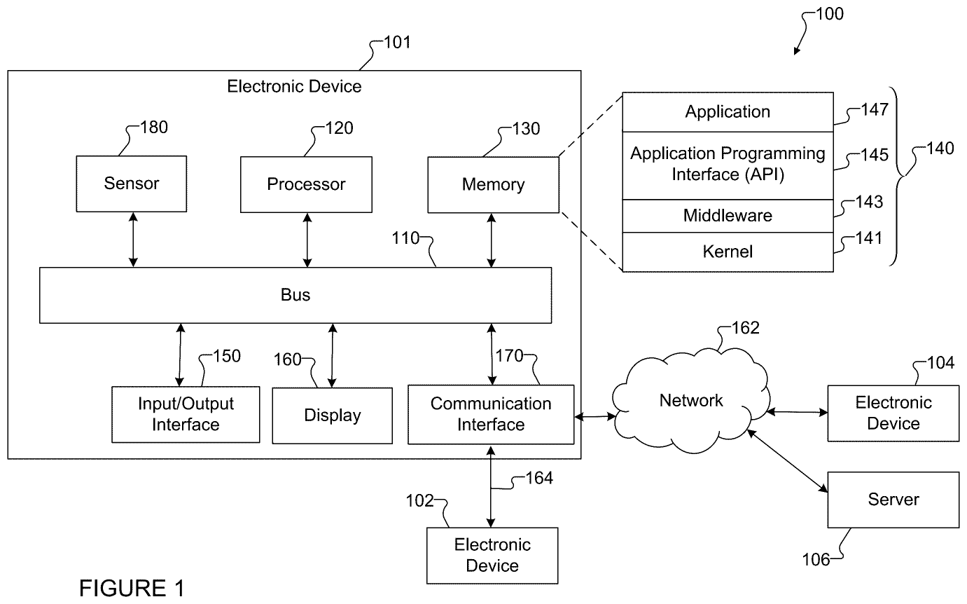

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, voice assistants have grown in popularity and the number of devices supporting voice assistant has increased. Robust voice recognition is important, otherwise errors can propagate to other tasks. Automated Speech Recognition (ASR) models can be trained in a variety of ways, such as via supervised, self-supervised, and semi-supervised training. For each type of training, it is important to have a correct balance of words (Audio or Text) present in the training data for the model to generalize and cover all scenarios. Many of the utterances directed towards voice assistant include named entities (NEs), and these NEs are becoming more complex.

NEs are no longer limited to phone contacts but also include songs and TV show names to be played on various types of devices, such as smartphones, fridges, or televisions. To measure and improve ASR performance, human graders manually listen to the audio and add a text Ground Truth (GT) to it. Additional meta data is often also added, such as whether a detected presence of an NE in the utterance is true or false, and, if true, a category for the NE, such as a TV show, phone contact, song name, etc., is added. This can be restrictive because only a few thousand utterances are graded and used for training, and the manual grading is used only once. The audio and GT pair is often used ASR training, and, to train a language model (LM), named entities are expanded using a set of patterns. However, this is restrictive in the sense that not all named entity can be expanded using the same set, and all NEs in a category that are expanded are still surrounded by the same words. This can cause the LM to overfit on the pattern, rather than improving on NE recognition. Although the determined NE is added back to the training, when spoken in a different context, the output from the system can be inaccurate.

Moreover, large amounts of money are often spent on acquiring data corpora targeted towards NE. Data corpora, however, are limited in the sense that they include generic NE, and patterns are fixed before the data collection begins. Hence, each utterance is not specialized according to the NE and the context provided by the NE is not used. For example, application names are in one NE category, but messages and camera application are different, and hence, apart from commands like “Close Application XYZ” and “Open Application XYZ,” user experience would be improved if utterances like “send a message using XYZ” and “take a selfie using XYZ” are part of training.

As described above, collecting data that includes NEs use a large amount of resources, including both manpower and financial resources, grading actual user data provides for higher performance, but is expensive and the output is only used once, text data augmentation by expanding patterns like “Call ABC” or “Open XYZ” are restrictive and do not use the context provided by the NE, off-the-shelf data corpora are expensive and still generic and may not contain all the NE used by a user in the recent past, and third party contracts for data recording is expensive and restrictive because the patterns and NEs are decided months in advance and the context of the NE is not used.

Previous approaches also experience poor performance of the ASR models with respect to NE recognition. Name Entity (NE) can be very user-specific, and hence its pronunciation and spelling vary from user to user. Obtaining graded Audio and GT pairs are can also be difficult for ASR training. Moreover, an NE is only added back to training with a single context. So, the next time the user uses the same NE in a different context, the performance might not be sufficient. Set patterns like “Call Mom” or “Open XYZ,” which are popular virtual assistant utterances, leads to patterns that are only expanded in a certain way, which in turn leads to ASR model overfitting. Also, audio generated by Text-To-Speech (TTS) software on the basis of fixed patterns leads to poor performance not only with respect to NE recognition but with respect to other words as well because the data tends to become less diverse.

This disclosure provides for automatic updating of automatic speech recognition for named entities. The embodiments of this disclosure provide ways to improve NE Recognition for artificial intelligence applications such as virtual assistants by training/updating improved ASR and LM models, expanding and augmenting audio and text corpora by including more variations of actual user spoken NEs, and making use of the context provided by the NE and diversification using a Large Language Models (LLMs) to cover generic and special use cases.

The LLMs of this disclosure are powerful tools that generate text. Having been trained on billions of utterances, the LLMs are very good at using context and generating utterances which are on topic. LLMs can be resource intensive with respect to memory, size and latency. Thus, embodiments of this disclosure may not directly integrate LLMs into a voice assistance, as this may result in the voice assistant becoming resource intensive, but instead can use LLMs offline for data augmentation, resulting in one-time offline usage while still increasing performance of voice assistants and ASR.

This disclosure provides an end-to-end system to update ASR models by generating/augmenting data using graded data of actual user spoken NEs. The system uses an automated prompt generation for the LLMs to expand the training corpus for named entities in a diverse setting and/or with personalized user information. This disclosure also provides systems and processes to train production voice assistant components such as ASR and/or LM models using a pretrained LLM. The methods of this disclosure can use indirect integration of LLMs into the ASR system without any additional latency or memory usage during ASR training and inference. An additional fine-tuning pipeline can also be included for the LLM based on real world ASR data and augmentation. The embodiments of this disclosure address the above-described issued with poor performance of preexisting ASR for NE recognition, high costs associated with NE data collection, restrictive pattern-based data augmentation and allowing for only a single use of expensive graded data.

The various embodiments of this disclosure provide for improved data set creation for named entity recognition, for which data is currently limited, improved ASR and/or language models in production, improved user experience due to personalization creating a feedback loop where the more the user uses a voice assistant, the better the experience will be, improvement of talk-to-speech by increasing vocabulary while improving ASR training, and integration of resource intensive LLMs in production voice assistants by indirectly training ASR models and/or language models.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may perform one or more functions related to automatic updating of automatic speech recognition for named entities using an LLM.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform automatic updating of automatic speech recognition for named entities using an LLM. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to automatic updating of automatic speech recognition for named entities using an LLM.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

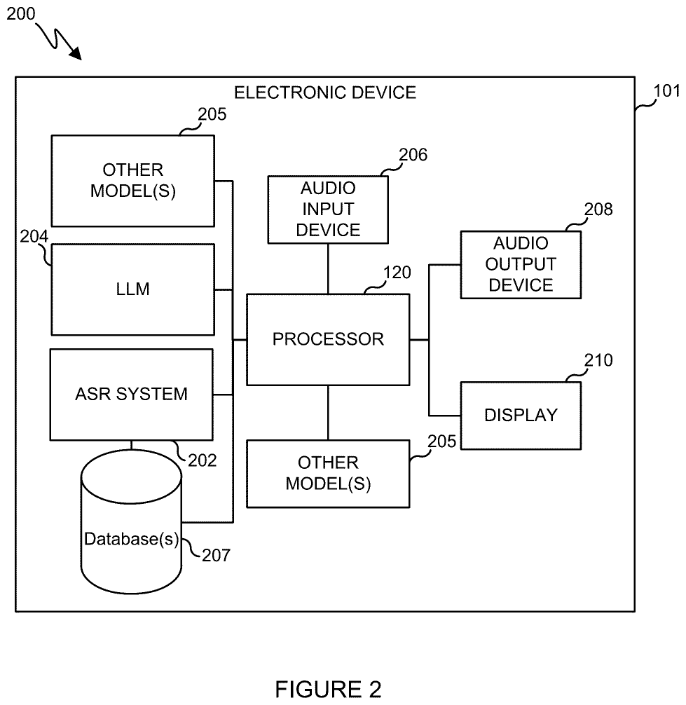

FIG. 2 illustrates an example voice assistant and named entity recognition system 200 in accordance with this disclosure. For ease of explanation, the system 200 is described as involving the use of the electronic device 101 in the network configuration 100 of FIG. 1. However, the system 200 may be used with any other suitable electronic device(s), such as the server 106, and in any other suitable system(s).

As shown in FIG. 2, the system 200 includes the electronic device 101, which includes the processor 120. The processor 120 is operatively coupled to or otherwise configured to use one or more machine learning models, such as an automated speech recognition (ASR) system 202 and a large language model (LLM) 204. The ASR system 202 can be trained to recognize aspects of user utterances provided to the ASR system 202, such as wake words or phrases, device and/or application specific commands/tasks, etc. The ASR system 202 can operate to convert speech into text. In some embodiments, the ASR system 202 can include a language model (LM) as part of the ASR system 202, which can, in various embodiments, compute the probability that any given word is a next one. As described in this disclosure, the ASR system 202 can also identify named entities from audio inputs and transmit identified named entities to other components, such as the LLM 204. As also described in this disclosure, the LLM 204 can receive the identified named entities, process them to generate updated named entity recognition data, and provide the updated data back to the ASR system 202.

The processor 120 can also be operatively coupled to or otherwise configured to use one or more other models 205, such as one or more NLU models. It will be understood that the machine learning models 202-205 can be stored in a memory of the electronic device 101 (such as the memory 130) and accessed by the processor 120 to perform automated speech recognition and named entity recognition tasks. However, the machine learning models 202-205 can be stored in any other suitable manner.

The system 200 also includes an audio input device 206 (such as a microphone), an audio output device 208 (such as a speaker or headphones), and a display 210 (such as a screen or a monitor like the display 160). The processor 120 receives an audio input from the audio input device 206 and provides the audio input to the trained ASR system 202. The trained ASR system 202 detects named entities in the utterance, as well as other components of the utterance such as intent, and outputs a result to the processor 120, such as one or more prediction or hypothesis of a named entity. The processor 120 can store the hypothesis in a database 207 on the electronic device 101. The LLM 204 can use the hypothesis stored in the database 207 in conjunction with prompts generated by an automated prompt generator to create more text with the named entities from the database 207. This additional text including the named entities can then be used as additional training data to further train the ASR system 202 to better recognize the named entity.

Once a named entity is determined using the ASR system 202, the processor 120 can instruct at least one action of the electronic device 101 or of another device or system. As a particular example, assume an utterance is received from a user via the audio input device 206 including a wake word or phrase (such as “play Rolling Stones”). Here, the processor 120, using the trained ASR system 202, detects the presence of the named entity “Rolling Stones,” and determines an application to play music including that named entity as an artist. The processor 120 then instructs a music application to play music by that named entity and the audio output device 208 outputs the music from the music application and the display 210 can display the music application interface. It will be understood that execution of other applications can be triggered in this way, such as phone applications, email applications, video streaming applications, etc. by determining user intent and a target named entity such as a phone contact, an email contact, a television program, etc.

Although FIG. 2 illustrates one example of a voice assistant and named entity recognition system 200, various changes may be made to FIG. 2. For example, the audio input device 206, the audio output device 208, and the display 210 can be connected to the processor 120 within the electronic device 101, such as via wired connections or circuitry. In other embodiments, the audio input device 206, the audio output device 208, and the display 210 can be external to the electronic device 101 and connected via wired or wireless connections. Also, in some cases, the ASR system 202, the LLM 204, as well as one or more of the other machine learning models 205, can be stored as separate models on the electronic device 101 called upon by the processor 120 to perform certain tasks, or can be included in and form a part of one or more larger machine learning models. Although in some embodiments the machine learning models 202-205 can be stored all on the same electronic device 101, in some embodiments, one or more of the machine learning models 202-205 can be stored remotely from the electronic device 101, such as on the server 106. Here, the electronic device 101 may transmit requests including inputs (such as captured audio data) to the server 106 for processing of the inputs using the machine learning models, and the results can be sent back to the electronic device 101. In addition, in some embodiments, the electronic device 101 can be replaced by the server 106, which receives audio inputs from a client device and transmits instructions back to the client device to execute functions associated with instructions included in utterances.

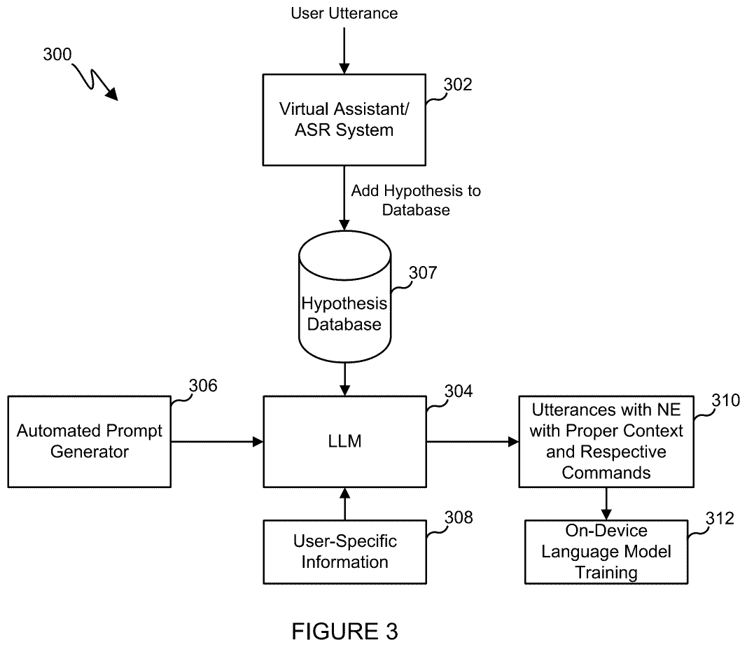

FIG. 3 illustrates an example process 300 for automatically updating an on-device ASR system for named entity recognition in accordance with this disclosure. For ease of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s).

In prior systems, an ASR training pipeline would include a database that receives up to millions of utterances each day, and graders would need to manually transcribe thousands of utterances before they can be used to train the ASR system. Thus, prior systems do not possess a way to automate the process of training/updating the ASR system, whether the system is deployed on a server or on-device.

As shown in FIG. 3, the process 300 includes receiving a user utterance by a virtual assistant and/or ASR system 302 stored and executed on-device, which can be the ASR system 202 described with respect to FIG. 2. The ASR system 302 identifies one or more named entities within the speech data associated with the user utterance. The predicted named entities, i.e., the hypothesis, is stored in a hypothesis database 307, which can be the database 207. In various embodiments, all hypotheses generated by ASR system 302 are stored in the on-device hypothesis database 307.

At least one of the identified named entities from the hypothesis database 307 is then provided to an LLM 304, which can be the LLM 204. An automated prompt generator 306 generates a plurality of prompts. In some embodiments, the automated prompt generator 306 can be used to access a set of audio samples of named entities collected from users of the voice assistance system 302, where each audio sample is annotated with a text transcript of the named entity and a category that the named entity belongs to, and, for each audio sample a prompt is generated including the named entity based on the corresponding category. The LLM 304 takes these prompts from the automated prompt generator 306 and the hypothesis from the hypothesis database 307 to create updated named entity data for use in training the ASR system 302, that is, more text including the named entities, such as additional utterances. That is, based on the prompts input to the LLM 304, the LLM 304 is configured to output a plurality of possible commands to the voice assistance system 302 including the named entity.

In some embodiments, the LLM 304 can also be provided with user-specific information 308. The user-specific information 308 can include user specific data and contexts, such as on-device contact details such as phone and/or email contacts, on-device content such video streaming services, playlists, stored music, etc., on-device applications, device location, device calendar data, etc. The user-specific information 308 can be used by the LLM 304 to verify the correct spelling for the named entities before generating the training utterances, which reduces LLM hallucination and provides outputs that are richer in user context.

Updated named entity recognition data 310 is generated by the LLM 304. The updated named entity recognition data 310 can include new utterances generated by the LLM 504 having the named entity, a proper context, and respective commands. The updated named entity recognition data 310 is provided from the on-device LLM 304 to the on-device ASR system 302 to train, at step 312, the on-device ASR system 302. In various embodiments, step 312 involves directly training a language model (LM) of the ASR system 302. Step 312 includes training the ASR system 302 with the received updated named entity recognition data from the LLM 304 to enhance named entity recognition accuracy. In some embodiments, a text-to-speech model can also be updated using the plurality of possible commands generated by the LLM 304.

During training of the LM model, the training can be based on use of a loss function. When the loss calculated by the loss function is larger than desired, the parameters of the LM model can be adjusted. Once adjusted, the same or additional training data can be provided to the respective LM model, and additional outputs from the LM model can be compared to the ground truths so that additional losses can be determined using the loss function. Over time, the LM model produces more accurate outputs that more closely match the ground truths, and the measured loss becomes less. At some point, the measured loss drops below a specified threshold, and training of the LM model is complete.

Although FIG. 3 illustrates one example of a process 300 for automatically updating an on-device ASR system for named entity recognition, various changes may be made to FIG. 3. For example, various components and functions in FIG. 3 may be combined, further subdivided, replicated, or rearranged according to particular needs. Also, one or more additional components and functions may be included if needed or desired. Also, as described in this disclosure, although the process 300 is described as being performed using an on-device architecture, the process 300 could be implemented or configured to be performed using a distributed architecture. While deployment on-device such as described in FIG. 3 maximizes user privacy, deployment of the process 300 using a distributed architecture could still be performed, and can include a step to anonymize user data. As another example, in some embodiments, the process 300 can include periodically updating the prompt generator 306, the LLM 304, and the ASR system 302 through application updates and then personalized again using the database 307 to ensure resource intensive tasks, like the addition of new features and architecture changes, takes place on an organization's server, while personalization takes place on the client device to maximize user privacy.

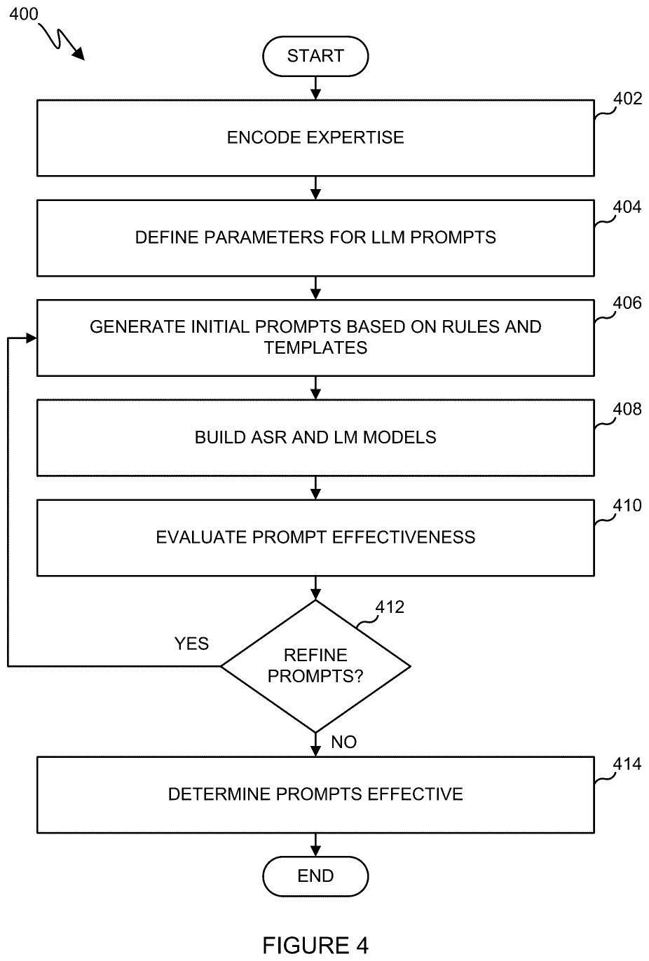

FIG. 4 illustrates an example method 400 for automating prompt generation in accordance with this disclosure. For ease of explanation, the method 400 shown in FIG. 4 is described as being performed using the electronic device 101 in the network configuration 100 of FIG. 1. However, the method 400 could be performed using any other suitable device(s), such as the server 106, and in any other suitable system(s).

The method 400 includes training a prompt generator, such as by the prompt generator 306, that automatically generates unique prompts for use by an LLM, such as the LLM 304. In various embodiments, the method 400 generates unique prompts for each known or available category for a virtual assistant. This enables the generation of many new utterances or commands by the LLM, addressing a problem where use of a single prompt for training was too generic for all possible categories to which a named entity may belong. Since the automated prompts are tested on the validation test containing the named entity, with each iteration the modified prompt is only rewarded when the utterances fed into ASR training are rich in named entities.

To train the prompt generator, at step 402, expertise is encoded, which can include a grading of actual user utterances, adding category labels, and/or providing different spellings for certain proper nouns. In some embodiments, step 402 is performed by linguists/data-scientists/engineers to provide base data to use for prompt generation. At step 404, parameters for the LLM prompts are defined to establish complexity, coherence, effectiveness, etc. of the prompts to be generated using the automated prompt generator. The parameters can include sentence length, smaller-LLM chaining to generate new prompts, and fine-tuning the LLM for hand crafted prompts or based on performance. At step 406, initial prompts are generated based on rules and templates, as well as based on the expertise and parameters encoded and defined at step 402 and 404. Other data to consider during prompt generation include voice assistant scenarios, categories (where prompts can be generic enough to cover all named entities in a category and specific enough to be domain relevant), and a focus on named entities specifically.

At step 408, ASR and LM models can be built with different data ratios and new data associated with the prompt generation. Using the ASR and LM models, at step 410, prompt effectiveness is evaluating. This can include using a validation set to calculate word errors rates (WERs) and sentence error rates (SERs) of the prompts generated by the prompt generator at step 406. In various embodiments, when validating the prompts, lower numbers are better. That is, while creating a next prompt, more weight is given to prompts with lower WERs and lower SERs.

At step 412, it is determined whether to refine the prompts based on the evaluation of prompt effectiveness performed at step 410. If so, the method 400 moves back to step 406 to generate new, refined, prompts based on adjusted parameters, and to step 408 to adjust the ASR and LLM models. Refining the prompts can include changing smaller-LLM output generation either via fine-tuning or using Retrieval Augmented Generation (RAG) for zero-shot learning. This prompt refinement process can continue until a threshold accuracy is achieved. The refinement process can also include LLM output filtering in which, as a post processing step, sentences can be removed from the LLM's output if the sentences do not contain the named entity that is expected for the utterance. Hallucination during the method 400 is not necessarily unwanted, as, in the method 400, the ASR and LLM will improve as long as the utterance is grammatically correct, and the audio matches the text. If, at step 412, it is determined that prompts should no longer be refined, at step 414 the prompts are determined to be effective and the method 400 ends.

The generated prompts related to a named entity can be varied and can prompt the LLM to generate a variety of different commands to use for training the ASR system. For example, suppose the prompt is “give me short commands for asking voice assistant XYZ to connect with ‘Phoebe.’” In response, the LLM can generate a plurality of different commands, such as: “Hey XYZ, can you connect me with Phoebe?”; “Please call Phoebe for me, XYZ.”; “Hey XYZ, can you send a message to Phoebe asking her if she's free to talk?”; “XYZ, can you put me through to Phoebe's voicemail?”; and/or “Hey XYZ, can you tell me Phoebe's current status?” As another example, suppose the generated prompt suppled to the LLM is “please provide short utterances for a voice assistant related to channel “N B C.” In response, the LLM can generate a plurality of different commands, such as: “What's on NBC tonight?”; “Can you tell me the latest news from NBC?”; “When is the next episode of XYZ show airing on NBC?”; and/or “I missed last night's episode of XYZ show; can you tell me where I can watch it online?”

In these examples, “Phoebe” and “NBC” are the NEs. The ASR and LM trained on these utterances have much higher performance than ones trained on fixed patterns like “Call Phoebe” or “Message Phoebe.” As seen in the output, the LLM on its own is able to provide context related to the named entity. Moreover, since the outputs are diverse and in context, the ASR system is preemptively trained when the utterance spoken by a user is different next time an utterance is provided.

Although FIG. 4 illustrates one example of a method 400 for automated prompt generation, various changes may be made to FIG. 4. For example, while shown as a series of steps, various steps in FIG. 4 could overlap, occur in parallel, occur in a different order, or occur any number of times (including zero times).

In some scenarios where integration of the LLM with a production, on-device, ASR is not feasible because of high compute, high memory, and high GPU requirements, the LLM can be integrated at the training side, so that these requirements are handled offline and only once during a data generation step, and not during training or inference stages.

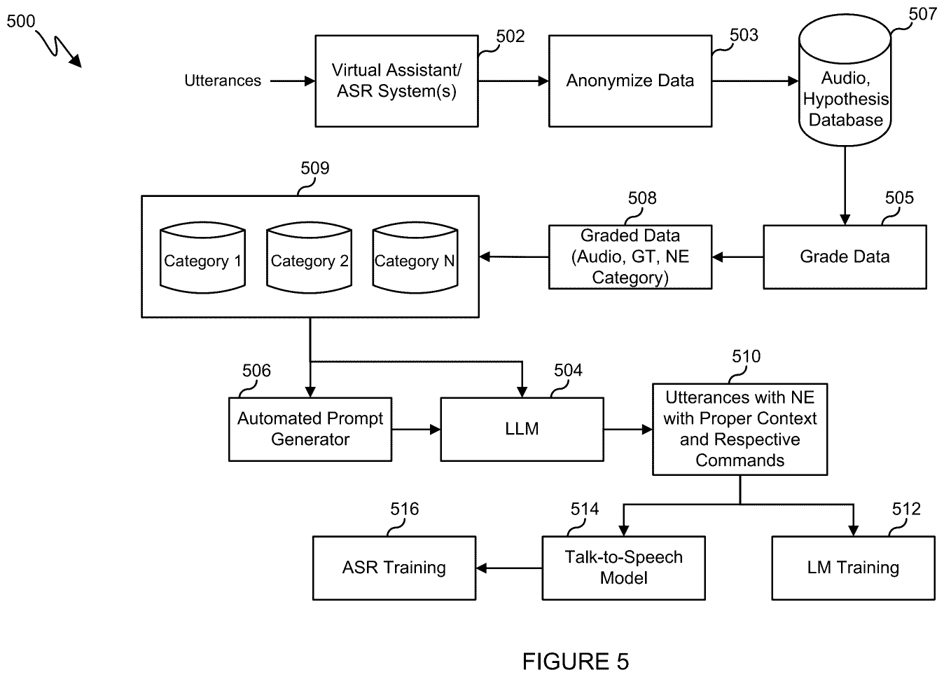

FIG. 5 illustrates an example process 500 for automatically updating an ASR system for named entity recognition using data pooling in accordance with this disclosure. For ease of explanation, the process 500 is described as involving the use of the server 106 in the network configuration 100 of FIG. 1. However, the process 500 may be used with any other suitable electronic device (such as the electronic device 101), or a combination of devices, and in any other suitable system(s).

As shown in FIG. 5, as utterances are received by virtual assistant and/or ASR systems 502, this data can be anonymized at step 503 and stored in an audio and hypothesis database 507 for use by a central processing center, such as the server 106. That is, instead of creating user-specific data for fully on-device environments, such as described with respect to FIG. 3, data can be collected from a plurality of client devices and pooled to create a base ASR model that can be periodically updated via over-the-air updates to the client devices as new data is gathered by the server 106 over time. These updates to ASR systems can be pushed periodically, such as every two months, to update the ASR system across client devices to support new features and to better recognize named entities based on the data collected and pooled over time. Pooling data in this way can lead to improved generalization for the ASR system, as well as allowing for collection of additional data for new features that can be released to the client device. Pooling data can also lead to improved personalization because the base model is of a higher accuracy.

As also shown in FIG. 5, data stored in the audio and hypothesis database 507 can be graded at step 505 and graded data 508 is provided for storage in one or more training databases 509. The graded data 508 can include audio samples, ground truths, and named entity categories. The graded data 508 can be stored within the training databases 509 based on the category for the named entity. For example, the training databases 509 can include categories such as an application name, a name of a person, a name of a television program, a name of a movie, a name of an electronic device, a name of a place, a name of a radio station, a name of a podcast, a name of a genre, a name of a business, a name of a sports team, a name of a song, etc. To train the ASR system, the data from the training databases 509 is provided to an LLM 504, which can be the LLM 204, and to an automated prompt generator 506, such as the automated prompt generator 306 also described with respect to FIGS. 3 and 4. The LLM 504 can be an existing prebuilt or fine-tuned LLM. The automated prompt generator 506 generates a plurality of prompts, using the categories of training data, by accessing the set of audio samples of named entities collected from users of the voice assistance system 502 stored in the training databases 509, where each audio sample is annotated with a text transcript of the named entity and a category that the named entity belongs to, and, for each audio sample a prompt is generated including the named entity based on the corresponding category. The LLM 504 takes these prompts from the automated prompt generator 506 to create updated named entity data for use in training the ASR system, that is, more text including the named entities, such as additional command utterances. That is, based on the prompts input to the LLM 504, the LLM 504 is configured to output a plurality of possible commands including named entities for use in training the ASR system.

Updated named entity recognition data 510 is generated by the LLM 504. The updated named entity recognition data 510 can include new utterances generated by the LLM 504 having the named entity, a proper context, and respective commands generated by the LLM 504. The updated named entity recognition data 510 is provided from the LLM 504 to perform, at step 512, training of an LM that is part of the ASR system. In various embodiments, the updated named entity recognition data 510 is also used to perform synthesis of audio samples using a talk-to-speech (TTS) model 514. The TTS model 514 can be used to synthesize audio samples based on LLM generated sentences. Since there are typically new NEs being created periodically, the TTS model 514 may not know how to pronounce novel NEs. In some embodiments, to ensure maximum TTS quality, words output from the LLM 504 can be checked against a TTS vocabulary pronunciation database, which can be part of the databases 509. In some cases, if a word is not already in the vocabulary pronunciation database, a linguist could add the pronunciation to the database to ensure proper synthesis. For example, for an LLM output of “I missed the new episode of XYZ show,” “XYZ” can be identified as out-of-vocabulary and a pronunciation transcription for “XYZ” can be added to the TTS vocabulary pronunciation database. The synthesized audio samples can then be used, at step 516, to perform training of the ASR system. In various embodiments, the TTS model 514 can also be trained using the utterances generated by the LLM 504.

During training of the models of the ASR system, the training can be based on use of a loss function. When the loss calculated by the loss function is larger than desired, the parameters of the models can be adjusted. Once adjusted, the same or additional training data can be provided to the respective models, and additional outputs from the models can be compared to the ground truths so that additional losses can be determined using the loss function. Over time, the models produce more accurate outputs that more closely match the ground truths, and the measured loss becomes less. At some point, the measured loss drops below a specified threshold, and training of the respective models is complete.

Although FIG. 5 illustrates one example of a process 500 for automatically updating an ASR system for named entity recognition using data pooling, various changes may be made to FIG. 5. For example, various components and functions in FIG. 5 may be combined, further subdivided, replicated, or rearranged according to particular needs. Also, one or more additional components and functions may be included if needed or desired.

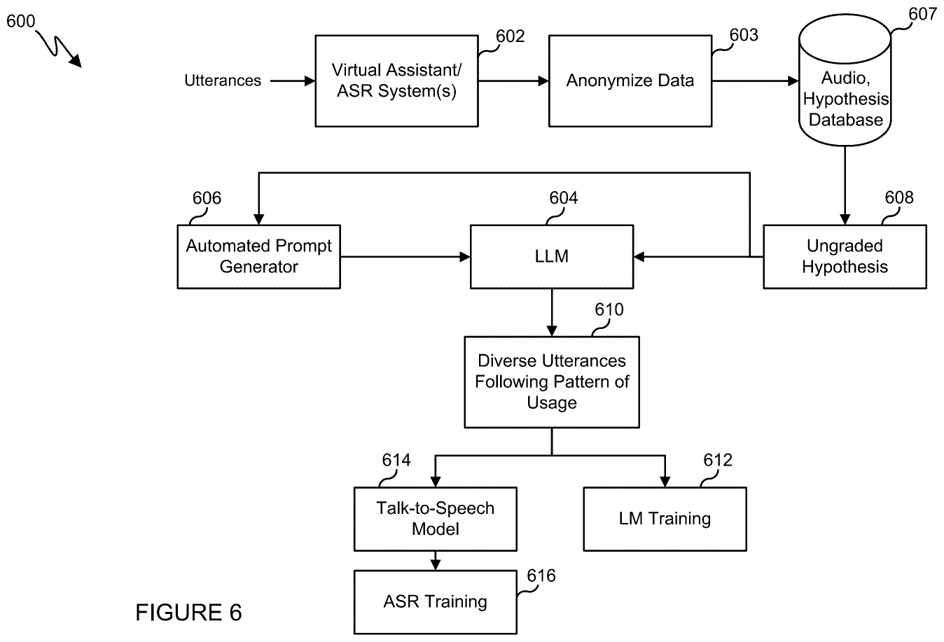

FIG. 6 illustrates an example process 600 for automatically updating an ASR system for named entity recognition using data pooling and ungraded hypotheses in accordance with this disclosure. For ease of explanation, the process 600 is described as involving the use of the server 106 in the network configuration 100 of FIG. 1. However, the process 600 may be used with any other suitable electronic device (such as the electronic device 101), or a combination of devices, and in any other suitable system(s).

As shown in FIG. 6, as utterances are received by virtual assistant and/or ASR systems 602, this data can be anonymized at step 603 and stored in an audio and hypothesis database 607 for use by a central processing center, such as the server 106. In this way, data can be collected from a plurality of client devices and pooled to create a base ASR model that can be periodically updated via over-the-air updates to the client devices as new data is gathered by the server 106 over time. These updates to ASR systems can be pushed periodically, such as every two months, to update the ASR system across client devices to support new features and to better recognize named entities based on the data collected and pooled over time. Pooling data in this way can lead to improved generalization for the ASR system, as well as allowing for collection of additional data for new features that can be released to the client device. Pooling data can also lead to improved personalization because the base model is of a higher accuracy.

As also shown in FIG. 6, instead of using all graded data like that described with respect to FIG. 5, ungraded hypotheses 608 from the audio and hypothesis database 607 can be used to create a diversified data corpus while still following a usage data distribution. To train the ASR system, the ungraded hypotheses 608 are provided to an LLM 604, which can be the LLM 204, and to an automated prompt generator 606, such as the automated prompt generator 306 also described with respect to FIGS. 3 and 4. The LLM 604 can be an existing prebuilt or finetuned LLM. The automated prompt generator 606 generates a plurality of prompts to the LLM 604 based on the named entity. The LLM 604 takes these prompts from the automated prompt generator 606 to create updated named entity data for use in training the ASR system, that is, more text including the named entities, such as additional command utterances. The LLM 604 can also check if the utterance contains a named entity and correct the spelling before generating utterances. That is, based on the prompts input to the LLM 604 and the ungraded hypotheses 608, the LLM 604 is configured to output updated named entity recognition data 610 that includes a plurality of diverse utterances following a pattern of usage.

The updated named entity recognition data 610 is provided from the LLM 604 to perform, at step 612, training of an LM that is part of the ASR system. In various embodiments, the updated named entity recognition data 610 is also used to perform synthesis of audio samples using a talk-to-speech (TTS) model 614. The TTS model 614 can be used to synthesize audio samples based on LLM generated sentences. Since there are typically new NEs being created periodically, the TTS model 614 may not know how to pronounce novel NEs. In some embodiments, to ensure maximum TTS quality, words output from the LLM 604 can be checked against a TTS vocabulary pronunciation database. In some cases, if a word is not already in the vocabulary pronunciation database, a linguist could add the pronunciation to the database to ensure proper synthesis. For example, for an LLM output of “I missed the new episode of XYZ show,” “XYZ” can be identified as out-of-vocabulary and a pronunciation transcription for “XYZ” can be added to the TTS vocabulary pronunciation database. The synthesized audio samples can then be used, at step 616, to perform ASR training of the ASR system. In various embodiments, the TTS model 614 can also be trained using the utterances generated by the LLM 604.

During training of the models of the ASR system, the training can be based on use of a loss function. When the loss calculated by the loss function is larger than desired, the parameters of the models can be adjusted. Once adjusted, the same or additional training data can be provided to the respective models, and additional outputs from the models can be compared to the ground truths so that additional losses can be determined using the loss function. Over time, the models produce more accurate outputs that more closely match the ground truths, and the measured loss becomes less. At some point, the measured loss drops below a specified threshold, and training of the respective models is complete.

Although FIG. 6 illustrates one example of a process 600 for automatically updating an ASR system for named entity recognition using data pooling and ungraded data, various changes may be made to FIG. 6. For example, various components and functions in FIG. 6 may be combined, further subdivided, replicated, or rearranged according to particular needs. Also, one or more additional components and functions may be included if needed or desired.

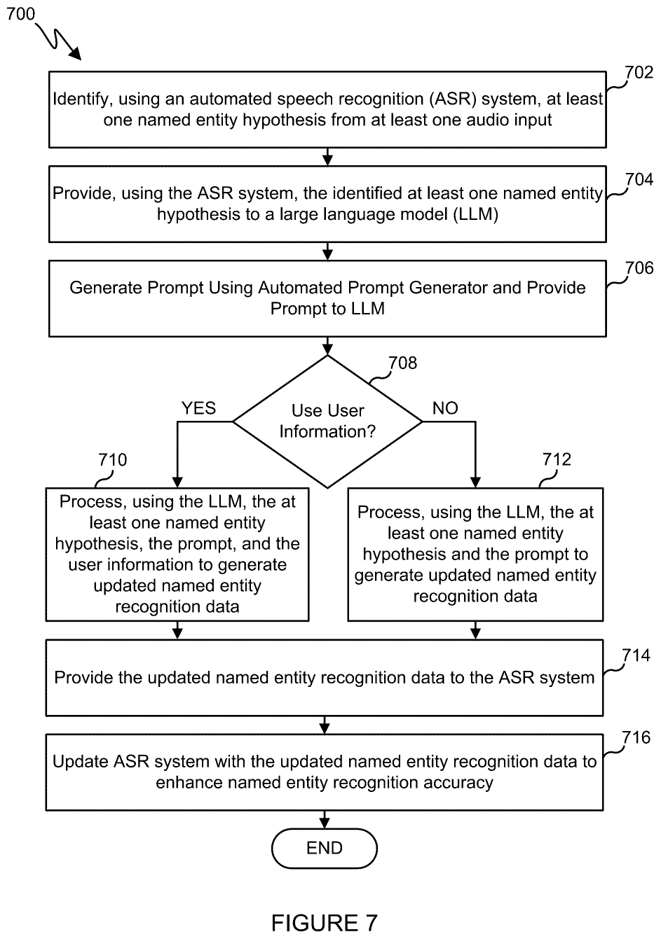

FIG. 7 illustrates an example method 700 for automatic updating of automatic speech recognition for named entities in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, at least one named entity hypothesis from at least one audio input is identified using an ASR system, such as the ASR system 202. At step 704, the identified at least one named entity hypothesis is provided, using the ASR system, to a large language model (LLM). At step 706, a prompt is generated using an automated prompt generator, such as the automated prompt generator 306. At step 708, it is determined whether to use user information, such as the user-specific information 308, to personalize the outputs of an LLM model, such as the LLM model 204. If so, at step 710, the identified at least one named entity hypothesis, the prompt, and the user information are processed using the LLM to generate updated named entity recognition data, such as updated named entity recognition data 310. The method 700 then moves to step 714.

If, at step 708, it is determined not to use user-specific information, at step 712, the identified at least one named entity hypothesis and the prompt are processed using the LLM to generate the updated named entity recognition data. The method 700 then moves to step 714. At step 714, the updated named entity recognition data is provided back to the ASR system. In various embodiments, the updated named entity recognition data includes a plurality of possible commands for use by the ASR system and/or a voice assistant system. In some embodiments, the ASR system and the LLM are executed on a same electronic device.

In some embodiments, generating the prompt at step 706 can include accessing a set of audio samples of named entities collected from users of a voice assistance system, i.e., to pool data from multiple user devices. In various embodiments, each audio sample can be annotated with a text transcript of the named entity and a corresponding category that the named entity belongs to of a plurality of categories. For each audio sample in the set of audio samples the prompt including the named entity can be generated based on the corresponding category, and this prompt can be provided as input to the LLM. In various embodiments, the plurality of categories includes at least one of an application name, a name of a person, a name of a television program, a name of a movie, a name of an electronic device, a name of a place, a name of a radio station, a name of a podcast, a name of a genre, a name of a business, a name of a sports team, or a name of a song. In various embodiments, the prompts for each of the plurality of categories are generated based on a set of rules.

At step 716, the ASR system is updated/trained with the updated named entity recognition data to enhance named entity recognition accuracy. In various embodiments, training the ASR system can include training a language model and/or a TTS model of the ASR system based on the plurality of possible commands generated by the LLM. In some embodiments, updating the ASR system can include providing the prompt generated using the automated prompt generator to a TTS model of the ASR system, synthesizing, using the TTS model, an audio sample based on the prompt, and training the ASR system using the synthesized audio sample. In various embodiments, a base model is created and the base model is trained using a set of audio samples of named entities collected from the multiple users of the voice assistance system. The ASR system and/or the LLM can then be periodically updated based on the base model.

Although FIG. 7 illustrates one example of a method 700 for automatic updating of automatic speech recognition for named entities, various changes may be made to FIG. 7. For example, while shown as a series of steps, various steps in FIG. 7 could overlap, occur in parallel, occur in a different order, or occur any number of times (including zero times).

It should be noted that the functions shown in FIGS. 2 through 7 or described above can be implemented in an electronic device 101, 102, 104, server 106, or other device(s) in any suitable manner. For example, in some embodiments, at least some of the functions shown in FIGS. 2 through 7 or described above can be implemented or supported using one or more software applications or other software instructions that are executed by the processor 120 of the electronic device 101, 102, 104, server 106, or other device(s). In other embodiments, at least some of the functions shown in FIGS. 2 through 11 or described above can be implemented or supported using dedicated hardware components. In general, the functions shown in FIGS. 2 through 7 or described above can be performed using any suitable hardware or any suitable combination of hardware and software/firmware instructions. Also, the functions shown in FIGS. 2 through 7 or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
identifying, using an automated speech recognition (ASR) system, at least one named entity hypothesis from at least one audio input;
providing, using the ASR system, the identified at least one named entity hypothesis to a large language model (LLM);
generating a prompt using an automated prompt generator;
processing, using the LLM, the identified at least one named entity hypothesis and the prompt to generate updated named entity recognition data; and
providing the updated named entity recognition data back to the ASR system.

2. The method of claim 1, further comprising updating the ASR system with the updated named entity recognition data to enhance named entity recognition accuracy.

3. The method of claim 2, further comprising:
accessing a set of audio samples of named entities collected from users of a voice assistance system, wherein each audio sample is annotated with a text transcript of the named entity and a corresponding category that the named entity belongs to of a plurality of categories;
for each audio sample in the set of audio samples:
generating the prompt including the named entity based on the corresponding category; and
providing the prompt as input to the LLM, wherein the updated named entity recognition data includes a plurality of possible commands including the named entity based on the corresponding category; and
training, based on the plurality of possible commands generated by the LLM, at least one of a language model or a talk-to-speech (TTS) model of the ASR system.

4. The method of claim 3, wherein the plurality of categories includes at least one of:
an application name;
a name of a person;
a name of a television program;
a name of a movie;
a name of an electronic device;
a name of a place;
a name of a radio station;
a name of a podcast;
a name of a genre;
a name of a business;
a name of a sports team; or
a name of a song.

5. The method of claim 3, further comprising:
creating a base model trained using the set of audio samples of named entities collected from the users of the voice assistance system; and
periodically updating the ASR system and/or the LLM based on the base model.

6. The method of claim 1, further comprising:
providing the prompt generated using the automated prompt generator to a talk-to-speech (TTS) model;
synthesizing, using the TTS model, an audio sample based on the prompt; and
training the ASR system using the synthesized audio sample.

7. The method of claim 1, wherein the ASR system and the LLM are executed on a same electronic device.

8. The method of claim 7, further comprising:
providing user information stored on the same electronic device to the LLM; and
processing, using the LLM, the identified at least one named entity hypothesis to generate the updated named entity recognition data using the user information.

9. An electronic device comprising:
at least one processing device configured to:
identify, using an automated speech recognition (ASR) system, at least one named entity hypothesis from at least one audio input;
provide, using the ASR system, the identified at least one named entity hypothesis to a large language model (LLM);
generate a prompt using an automated prompt generator;
process, using the LLM, the identified at least one named entity hypothesis and the prompt to generate updated named entity recognition data; and
provide the updated named entity recognition data back to the ASR system.

10. The electronic device of claim 9, wherein the at least one processing device is further configured to update the ASR system with the updated named entity recognition data to enhance named entity recognition accuracy.

11. The electronic device of claim 10, wherein the at least one processing device is further configured to:
access a set of audio samples of named entities collected from users of a voice assistance system, wherein each audio sample is annotated with a text transcript of the named entity and a corresponding category that the named entity belongs to of a plurality of categories;
for each audio sample in the set of audio samples:
generate the prompt including the named entity based on the corresponding category; and
provide the prompt as input to the LLM, wherein the updated named entity recognition data includes a plurality of possible commands including the named entity based on the corresponding category; and
train, based on the plurality of possible commands generated by the LLM, at least one of a language model or a talk-to-speech (TTS) model of the ASR system.

12. The electronic device of claim 11, wherein the plurality of categories includes at least one of:
an application name;
a name of a person;
a name of a television program;
a name of a movie;
a name of an electronic device;
a name of a place;
a name of a radio station;
a name of a podcast;
a name of a genre;
a name of a business;
a name of a sports team; or
a name of a song.

13. The electronic device of claim 11, wherein the at least one processing device is further configured to:
create a base model trained using the set of audio samples of named entities collected from the users of the voice assistance system; and
periodically update the ASR system and/or the LLM based on the base model.

14. The electronic device of claim 9, wherein the at least one processing device is further configured to:
provide the prompt generated using the automated prompt generator to a talk-to-speech (TTS) model;
synthesize, using the TTS model, an audio sample based on the prompt; and
train the ASR system using the synthesized audio sample.

15. The electronic device of claim 9, wherein both the ASR system and the LLM are executed on the electronic device.

16. The electronic device of claim 15, wherein the at least one processing device is further configured to:
provide user information stored on the electronic device to the LLM; and
process, using the LLM, the identified at least one named entity hypothesis to generate the updated named entity recognition data using the user information.

17. A non-transitory machine readable medium containing instructions that when executed cause at least one processor of an electronic device to:
identify, using an automated speech recognition (ASR) system, at least one named entity hypothesis from at least one audio input;
provide, using the ASR system, the identified at least one named entity hypothesis to a large language model (LLM);
generate a prompt using an automated prompt generator;
process, using the LLM, the identified at least one named entity hypothesis and the prompt to generate updated named entity recognition data; and
provide the updated named entity recognition data back to the ASR system.

18. The non-transitory machine readable medium of claim 17, further containing instructions that when executed cause the at least one processor of the electronic device to update the ASR system with the updated named entity recognition data to enhance named entity recognition accuracy.

19. The non-transitory machine readable medium of claim 18, further containing instructions that when executed cause the at least one processor of the electronic device to:
access a set of audio samples of named entities collected from users of a voice assistance system, wherein each audio sample is annotated with a text transcript of the named entity and a corresponding category that the named entity belongs to of a plurality of categories;
for each audio sample in the set of audio samples:
generate the prompt including the named entity based on the corresponding category; and
provide the prompt as input to the LLM, wherein the updated named entity recognition data includes a plurality of possible commands including the named entity based on the corresponding category; and
train, based on the plurality of possible commands generated by the LLM, at least one of a language model or a talk-to-speech (TTS) model of the ASR system.

20. The non-transitory machine readable medium of claim 17, further containing instructions that when executed cause the at least one processor of the electronic device to:
provide the prompt generated using the automated prompt generator to a talk-to-speech (TTS) model;
synthesize, using the TTS model, an audio sample based on the prompt; and
train the ASR system using the synthesized audio sample.
